(19) United States
(12) Patent Application Publication
(10) Pub. No.: US 2026/0311165 A1
(43) Pub. Date: Oct. 8, 2026

(54) SYSTEM AND METHOD FOR PASSIVE VIEWER ENGAGEMENT AND VERIFIABLE CONTENT INTERACTION

(71) Applicant: The Feature, Inc., Laguna Beach, CA (US)

(72) Inventor: Steven Ilous, Laguna Beach, CA (US)

(73) Assignee: The Feature, Inc., Laguna Beach, CA (US)

(21) Appl. No.: 19/481,811

(22) PCT Filed: May 3, 2024
(86) PCT No.: PCT/US2024/027667

§ 371 Date: Nov. 5, 2025

Related U.S. Application Data
(60) Provisional application No. 63/464,330, filed on May 5, 2023.

(51) Int. Cl. G06Q 20/36; G06Q 30/0214; G06Q 40/04

(52) U.S. Cl. CPC G06Q 20/36; G06Q 30/0214; G06Q 40/055; G06Q 2220/00

(57) ABSTRACT

A system and method for passively engaging viewers of digital content are provided. A server initiates a verification or smart-contract protocol upon a request from a viewing device to stream content. A viewer-associated account or wallet coupled to the server is registered under the protocol. Upon detecting completion or another designated milestone of the streamed content, an issuance function automatically generates an NFT or a unique digital asset, token, or record linked to the viewing event. The asset is transferred to the viewer's account without requiring manual transaction signatures, thereby improving the user experience while ensuring authenticity, traceability, and verifiable engagement.

### CROSS REFERENCE TO RELATED APPLICATION

This Application claims priority to U.S. Provisional Application No. 63/464,330 filed May 5, 2023, the contents of which are herein incorporated in full.

### BACKGROUND OF THE INVENTION

The present invention is directed to a structure and method for utilizing blockchain technology and more particularly, use of a non-fungible token (“NFT”), in a passive way, to encourage streaming content consumption over the internet.

Blockchain, although relatively new, is known for its use with documenting a history of an item or transaction. Blockchain verifies the transaction and history ownership of bitcoin, by way of example. It is known to be used to verify the authenticity of documents such as a deed for land. However, even with the advent of blockchain there is no simple way for using it with creating NFTs. To create an NFT one must search for an NFT of interest, and once found arrange for the purchase and transfer of the NFT to their wallet. This takes time and effort and may not always be successful, as one can be outbid or not even find a particular NFT of interest.

At the same time competition for eyeballs is fierce among content providers. Everything from trailers, to view based sweepstakes, to fan clubs with rewards are used to create affinity groups to encourage content viewership. However, each of these approaches suffers from the disadvantage that it takes significant action by the viewer to reap any benefit. Given the amount of effort required to participate in these programs, it suffers from the disadvantage that it only appeals to those already significantly engaged in the content. It does not give a true read to viewership, nor does it provide encouragement for the moderately engaged viewer to become more engaged. Despite the vast array of engagement strategies currently employed to capture and retain audience attention, many fail to reach their full potential due to their limited scope and the significant effort required from viewers.

Accordingly, a structure and methodology making use of the unique NFTs, to further engage viewers, to overcome the shortcomings of the prior art, is provided.

### SUMMARY OF THE INVENTION

A method for passively engaging a consumer of streamed content comprises providing a digital playback device. A server calls a smart contract upon a request from the device to stream a content to the device. A wallet is coupled to the server, the wallet being subject to the smart contract. Content is streamed to the device in response to a request for the content. A completion of the streaming of the content is determined. A mint function for minting NFTs communicates with the server in accordance with the terms of the smart contract. The mint function receiving a signal from the server, and in accordance with the smart contract, generating an NFT to be transferred to the wallet as a function of the signal indicating that one of a designated marker, or a completion of the content has occurred.

In one preferred embodiment the NFT is of a theme related to the content. In another embodiment the NFT may be a coupon for further purchases.

In the preferred embodiment, the content is one of videos, music, podcasts, live broadcasts, educational courses, interactive experiences and virtual reality content.

In one preferred embodiment, the transmission of the content to the viewer is enabled by the existence of the wallet connected to the smart contract.

### BRIEF DESCRIPTION OF THE DRAWINGS

The present disclosure will be better understood by reading the written description with reference to the accompanying drawing figures in which like reference numerals denote similar structure and refer to like elements throughout in which:

FIG. 1 a block diagram of a system for enabling the use of NFTs linked to streaming content in accordance with the invention; and

FIG. 2 is a flowchart of the NFT based content viewing process in accordance with the invention.

### DETAILED DESCRIPTION OF THE PREFERRED EMBODIMENTS

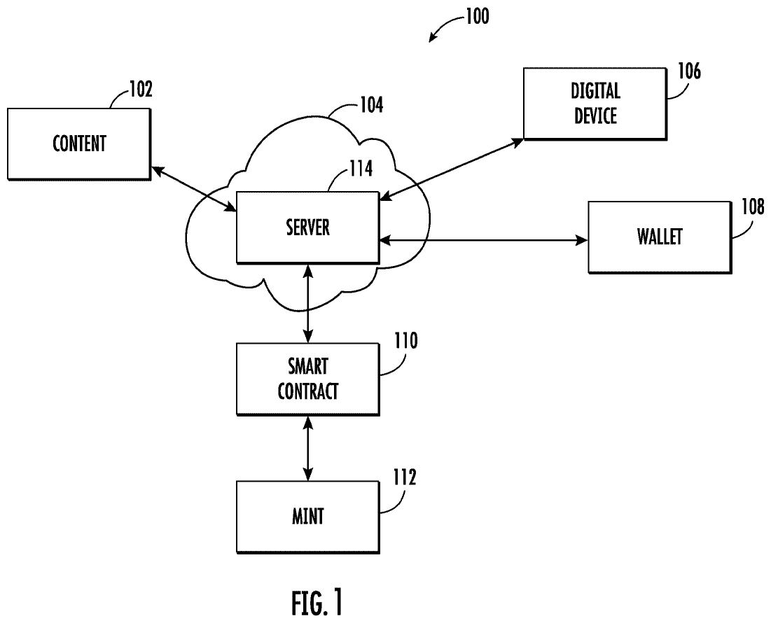

Reference is first made to FIG. 1 in which a system 100 for enabling the process of the invention is provided. System 100 includes a content source 102 for storing content of interest. A digital playback device, an over-the-top hardware viewing device 106, in this exemplary, non-limiting embodiment of the invention, such as a computer, smart phone, tablet or the like capable of receiving and displaying online video content, communicates with content source 102.

Viewing device 106 streams content from content 102 through a cloud 104 utilizing one or more servers 114 forming part of cloud 104.

A mint function 112 for creating NFTs communicates with cloud 104. A wallet 108 associated with a person consuming content from content source 102 at viewing device 106 communicates with mint function 112 across cloud 104.

A smart contract 110 associated with wallet 108 and content source 102, communicates with mint function 112, content source 102 and/or viewing device 106. As will be discussed in greater detail below, smart contract 110 determines the existence of wallet 108, then as function thereof, determines when content from content 102 has been completely streamed to viewing device 106, and causes the minting of an NFT by mint function 112 to be deposited in wallet 108.

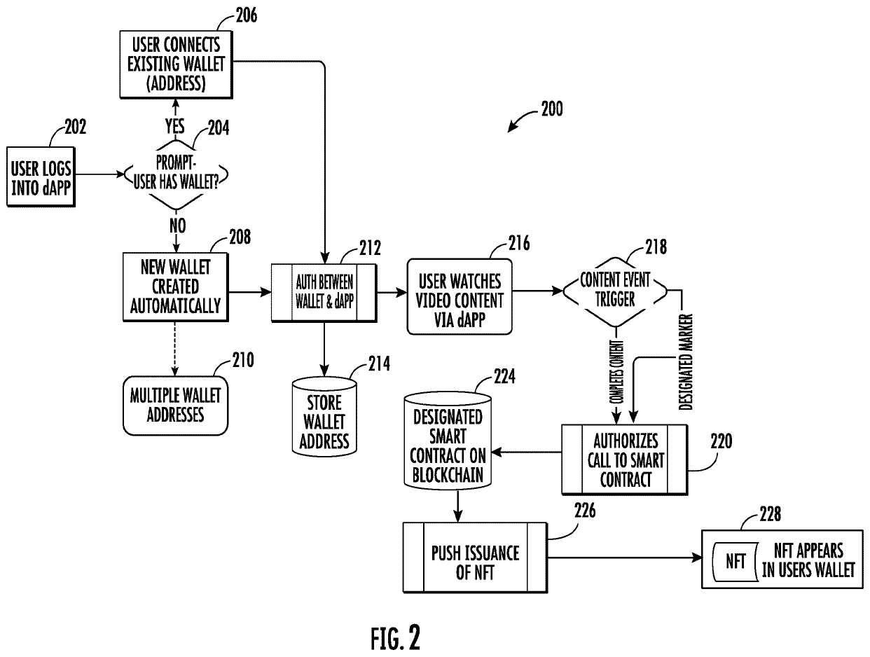

Reference is now made to FIG. 2 wherein the method of operation 200 of the system 100 in accordance with the invention is provided. A user will log into the platform (digital application, “dApp”) from viewing device 106 as with any other content providing system in a step 202. The server 114 in cloud 104 prompts the user at viewing device 106 whether the user has a wallet 108 in a step 204. If yes, then preexisting wallet 108 is placed in communication with server 114. If it is determined that there is no preexisting wallet 108 associated with viewing device 106, and in turn the user associated with the device 108, as determined in step 204, then a new wallet 108 associated with server 114 and the remaining architecture is created for the user in a step 208. It should be noted multiple wallet addresses will be created for the number of users in a step 210. It should also be noted that the logic of the system 100 is user based, not viewing device 106 based, so that a user can make use of the method across a series of viewing devices 106 they may use.

In a step 212 the user authorizes the link, through the smart contract 110, between wallet 108 and the application. As part of the initial registration process, the user agrees to the terms of the smart contract 110; linking the wallet to the application, enabling viewing of content from content store 100, and the receipt of NFTs minted by mint function 112 in accordance with certain rules described below in a step 212. Server 114 stores the wallet address for later use in a step 214. This process through step 214 does not have to be repeated as system 100 is now initialized for use.

In a step 216 a user watches streaming content at over-the-top viewing device 106. The content is streamed from content store 102 through server 114 to viewing device 106 in response to a request from the user. Server 114 monitors the streaming and, in a step 218, determines when the content streaming has been completed. In a step 220 server 114, authorizes a call to the smart contract 110 on the block chain created during initialization above. The smart contract 110, authorizes a call to mint function 112 to create the NFT in a step 226. The NFT then appears in the user's wallet 108 in a step 228 without any additional action by the user. The watching of the video itself, creates the NFT and pushes it to the wallet 108 of the associated viewer.

It should be noted that in the preferred embodiment, to encourage completion of the video content the authorization to mint the NFT occurs at the end of the streamed content. However, it is within the scope of the invention for designated markers to be triggered while the content is streaming. These designated markers authorize the call to smart contract 110 in step 220, causing an NFT to be minted and transferred to wallet 108 while the content is streaming; prior to completion.

As a result of the above-described system and method, it becomes possible to passively associate an NFT with the viewing of the video. Because the content can only be viewed by those with registered wallets, the wallet acts as a gatekeeper to the content. At the same time, it is passively providing increased play value or enjoyment to the viewing experience by providing a targeted NFT to each viewer. It further encourages the viewer to stream this particular content. It should be noted that in a less passive embodiment an optical code can be provided, as part of the streamed content, the optical code causing a link with an NFT upon scanning with a smart device.

Applicant notes that the above description was provided in connection with consumption of streamed video content. However, The invention also operates in the same way for not only videos but also other streaming content, such as, music, podcasts, live broadcasts, educational courses, interactive experiences, and virtual reality content. By leveraging non-fungible tokens (NFTs), this method aims to universally incentivize and enhance engagement with streaming content across the internet, breaking traditional boundaries of digital media consumption.

The invention presents a universal engagement model that utilizes a blockchain-based smart contract to mint NFTs in response to engagement with any form of streaming content. This model is applicable to watching videos, listening to music, participating in live streams, engaging with educational material, or interacting with virtual and augmented reality content. Upon reaching a significant level of engagement or interaction, participants are rewarded with thematic NFTs, designed to enhance the value and enjoyment of the streaming experience across all types of content.

As a result of the current invention, blockchain technology, known for its revolutionary approach to verifying transactions and authenticating ownership histories, is now adapted to interact with a wide array of digital content. The conventional method of acquiring an NFT, which often involves a complex and time-consuming process, is simplified and made more accessible, facilitating a deeper connection between content providers and their audience across all forms of media.

As a result, this invention introduces a novel system and method that uses unique NFTs to foster universal engagement, addressing the limitations of current strategies and blockchain applications in the context of diverse digital media streaming. Furthermore, by tying completed viewing to the issuance of NFTs to registered wallets, actual viewership can be more accurately tracked. As a result of the wallet registration process more information can be determined about the actual viewing audience.

The method ensures authenticity, immutable viewer metrics, and a uniqueness of the NFTs using blockchain technology in an over-the-top streaming environment. The use of the block chain not only ensures the uniqueness and the authenticity of the NFT related to the content but provides a novel user experience as the NFT issuance does not require transaction signatures which detract from the overall user/viewing experience.

It will thus be seen that the objects set forth above, among those made apparent from the preceding description, are efficiently attained and, since certain changes may be made in carrying out the above method and in the construction set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

1. A method for passively engaging a consumer of content comprises the steps of:
providing a digital playback device;
providing a server, the server in communication with the digital playback device, the server being enabled to initiate a smart contract upon a request from the digital playback device to stream a content to the digital playback device;
providing a wallet communicating with the server, the wallet being subject to the smart contract;
a content is streamed to the digital playback device in response to a request for the content from the viewing device;
a status of the streaming of the content is determined; and
providing a mint function, the mint function enabled to generate NFTs as a function of the status of the stream of content, the mint function communicating with the server;
the mint function receiving a signal from the server, and in accordance with the smart contract, generating an NFT to be transferred to the wallet as a function of the signal indicating that one of a designated marker, or a completion of the content has occurred.

2. The method of claim 1, wherein the content is one of videos, music, podcasts, live broadcasts, educational courses, interactive experiences and virtual reality content.

3. The method of claim 1, wherein the NFT is of a theme related to the content.

4. The method of claim 1, wherein the NFT may be a coupon for further purchases.

5. The method of claim 1, wherein the transmission of the content to the viewer is enabled by the existence of the wallet connected to the smart contract.

6. The method of claim 1, wherein actual viewership is tracked by linking completed viewing to the issuance of NFTs to registered wallets.

7. The method of claim 1, wherein the system ensures the authenticity, uniqueness, and immutability of the NFTs and viewer metrics using blockchain technology.

8. The method of claim 1, wherein the NFT issuance does not require transaction signatures, improving the overall user and viewing experience.

9. The method of claim 1, wherein the system can be adapted for various types of content, platforms, and devices.

10. The method of claim 1, wherein the system can incorporate additional incentives or rewards for viewers based on their engagement levels, social sharing, referrals, or other actions that benefit the content provider and the overall community.

11. A method for passively engaging a viewer of content, comprising the steps of:
providing a viewing device configured to stream a content;
providing a server in communication with the viewing device, the server being enabled to initiate a verification protocol upon a request from the viewing device to stream the content;
providing a wallet associated with a viewer and communicating with the server, the wallet being subject to the verification protocol;
streaming the content to the viewing device in response to the request;
determining a status of the streaming of the content; and
triggering an issuance function that, in accordance with the verification protocol, automatically generates and transfers an NFT to the wallet as a function of the status, wherein the transfer occurs without requiring user-initiated transaction signatures.

12. The method of claim 11, wherein the status of the streaming of the content includes a signal indicating that one of a designated marker has occurred.

13. The method of claim 11, wherein the status of the streaming of the content includes a signal indicating that completion of the streaming of the content has occurred.

14. The method of claim 11, wherein the NFT is one of a unique digital asset, token, and record.

15. The method of claim 11, wherein the NFT is thematically or contextually related to the content being viewed.

16. The method of claim 11, wherein the NFT functions as one of a coupon, loyalty point, and other reward redeemable for additional goods or services associated with a provider of the content.

17. The method of claim 11, wherein the content is one of videos, music, podcasts, live broadcasts, educational courses, interactive experiences and virtual reality content.

18. The method of claim 11, wherein the system can incorporate additional incentives or rewards for viewers based on their engagement levels, social sharing, referrals, or other actions that benefit the content provider and the overall community.

19. The method of claim 11, wherein the viewing device is one of a computer, smart phone, tablet and the like capable of receiving and displaying online video content.

20. The method of claim 11, wherein the system can be adapted for various types of content, platforms, and devices.
